(19) United States
(12) Patent Application Publication
(10) Pub. No.: US 2016/0266778 A1
(43) Pub. Date: Sep. 15, 2016

(54) Positionable User Interface for Vehicular Use

(71) Applicant: ATIEVA, INC., Menlo Park, CA (US)

(72) Inventor: Peter Dore Rawlinson, Worcestershire (GB)

(73) Assignee: ATIEVA, INC., Menlo Park, CA (US)

(21) Appl. No.: 14/644,273

(22) Filed: Mar. 11, 2015

(51) Int. Cl. G06F 3/0484; B60K 35/00; G06F 3/0488

(52) U.S. Cl. CPC G06F 3/04847; G06F 3/04842; G06F 3/0488; B60K 35/00; B60K 2350/1004

(57) ABSTRACT

A touch screen user interface is provided that is adjustable between at least two positions, and preferably adjustable over a range of positions. By providing the ability to adjust the interface's position, the user can optimize screen placement for either data entry or viewing. Additionally, the screen position can be optimized for the user's seating position. As a result, when the screen is being used for viewing, for example when the screen is being used with the navigation system, the user can easily see the screen without having to look downward or dramatically alter their viewing angle. Similarly, when the screen is being used for data entry, for example to input data into the navigation system or make adjustments to the audio system, the screen can be positioned so that the user can easily reach the interface without straining, thereby helping to avoid neck, shoulder and/or back pain.

### FIELD OF THE INVENTION

The present invention relates generally to vehicles and, more particularly, to an adjustable user interface for use in a vehicle.

### BACKGROUND OF THE INVENTION

The user interface of a modern car uses a variety of techniques to communicate with the passengers in general, and the driver in particular. Some aspects of the user interface are designed to provide the user with information that may be required to properly and safely operate the vehicle, information such as the vehicle's current speed, the gas level for a conventional car or the charge level for an electric vehicle, the selected gear, parking brake status, external light status, turn signal status, etc. Other aspects of the user interface may be designed to provide the user, either the driver or a passenger, with the current status of various secondary vehicle systems such as the entertainment system (e.g., volume level, selected source, selected track or station, etc.), the heating, ventilation and air conditioning (HVAC) system (e.g., fan settings, thermostat settings, defroster settings, air conditioner status, etc.), auxiliary lighting (e.g., fog lamps, passenger cabin lighting, etc.), navigation system, etc. Still other aspects of the user interface are configured to provide the user with control over the various vehicle systems (e.g., turn on the car, select a gear, turn on a light, activate a turn signal or the windshield wipers, adjust the external side mirrors, open/close the moon roof, adjust the HVAC settings, adjust the entertainment system settings, interact with the navigation system, etc.). In some cars, the vehicle's user interface is also designed to allow a user to interact with non-vehicle devices that are temporarily connected to the vehicle, devices such as the user's cell phone or an mp3 player.

While much of the information and control provided by a car's user interface is common from one vehicle to the next regardless of vehicle type or manufacturer, the way in which this information and control is provided can vary dramatically. Common user interface variables include the type of switches used (e.g., toggle, push button, capacitive, physical versus touch-sensitive, etc.) as well as the type and number of display screens (e.g., color versus black & white, touch sensitive versus non-touch sensitive, screen resolution, screen size, screen placement, single versus multiple screens, etc.). Due to these design variations, some interfaces may be easier to use than others, and some interfaces may be perceived as being more modern or more expensive/luxurious than others. Since these variations often impact car sales, car makers often go to great lengths to optimize their interface.

A modern trend in the design of user interfaces, at least in high-end vehicles, is the incorporation of a touch screen into the interface. The use of a touch screen provides a number of benefits. First, by altering the information displayed and accepted, a single touch screen can be used to control multiple vehicle systems and functions, thereby simplifying the interface and conserving dashboard space. Second, through the use of instructional diagrams and pictures, it can help the user to intuit a particular vehicle function or to improve the user's interaction with a particular vehicle control system (e.g., providing fine control over the position of the car's moon roof).

While the incorporation of a touch screen into a car's user interface may provide the user with improved interface control, it can also lead to a frustrating user experience. For example, a touch screen display that is mounted high on the dashboard may be easily viewed by either the driver or the front seat passenger, but may be difficult to reach when the user wants to interact with the touch screen (e.g., to make an adjustment to a particular vehicle system). Conversely, a display mounted to be close enough to the user to allow the user to easily reach and interact with the screen may not be easy to view, especially while driving. Accordingly, what is needed is a system that provides the benefits of a touch screen display without the limitations imposed by its mounting location. The present invention provides such a system.

### SUMMARY OF THE INVENTION

The present invention provides a vehicle interface system that includes (i) a user interface mounted within the passenger cabin of a vehicle, where the user interface is a touch screen, and where the user interface is adjacent to the vehicle's driver seat; (ii) a user interface positioning system (e.g., an electro-mechanical positioning system, a hydraulic positioning system, etc.) coupled to the user interface, where the user interface positioning system is adjustable between at least a first user interface position and a second user interface position, where the user interface in the first user interface position corresponds to a data entry position, where the user interface in the second user interface position corresponds to a viewing position, where the user interface in the data entry position is lower within the passenger cabin than when the user interface is in the viewing position, where the user interface in the data entry position is closer to the driver seat than when the user interface is in the viewing position, and where the user interface in the viewing position is closer to a vehicle windshield than when the user interface is in the data entry position; and (iii) a user interface position selector coupled to the user interface positioning system, where the user interface position selector is settable to a least a first setting and a second setting, where the user interface position selector in the first setting causes the user interface positioning system to place the user interface in the first user interface position, where the user interface position selector in the second setting causes the user interface positioning system to place the user interface in the second user interface position, and where the user interface position selector is settable by a vehicle driver. Preferably when the user interface is in the data entry position it is within 30 degrees of the horizontal plane and when the user interface is in the viewing position it is within 45 degrees of the vertical plane. The user interface may be centrally located between the driver seat and the adjacent passenger seat. The user interface position selector may be configured to be settable to any of a plurality of settings between the first and second settings, where the plurality of settings corresponds to a plurality of user interface positions between the data entry position and the viewing position.

In one aspect, the vehicle interface system includes a linkage assembly that is controllable by the user interface positioning system, where the user interface is mounted within the vehicle's passenger cabin using the linkage assembly, and where the user interface positioning system utilizes the linkage assembly to adjust the user interface between at least the first user interface position and the second user interface position based on an input from the user interface position selector. The linkage assembly may include a guide track mounted to the vehicle, where a link of the linkage assembly slides within the guide track, where a position of the link within the guide track is controlled by the user interface positioning system, and where the user interface positioning system positions the link of the linkage assembly within the guide track in order to adjust the user interface between at least the first and second user interface positions based on input from the user interface position selector; alternately, the linkage assembly may include a guide track mounted to a portion of the user interface, where the guide track moves about a pivot mounted to the vehicle, where a position of the guide track relative to the pivot is controlled by the user interface positioning system, and where the user interface positioning system positions the guide track relative to the pivot to adjust the user interface between at least the first and second user interface positions based on the input from the user interface position selector; alternately, the linkage assembly may include at least one link (which may be a telescoping link) that couples a user interface hinge mount to a passenger cabin hinge mount, where the user interface hinge mount is attached to a rear portion of the user interface and the passenger cabin hinge mount is fixed to the vehicle's passenger cabin.

In another aspect, the user interface position selector may be comprised of a rotatable knob, where the rotatable knob rotated to a first position corresponds to the first setting and rotated to a second position corresponds to the second setting. The rotatable knob may be settable to any of a plurality of settings between the first and second positions, where the plurality of settings corresponds to a plurality of user interface positions between the data entry position and the viewing position.

In another aspect, the user interface position selector may be comprised of a first switch and a second switch, where activation of the first switch selects the first setting and activation of the second switch selects the second setting. The first and second switches may correspond to first and second push button switches; alternately the first and second switches may correspond to first and second touch sensitive regions on the user interface.

In another aspect, the user interface position selector may be comprised of a first switch and a second switch, where activation of the first switch causes the user interface positioning system to move the user interface in a first direction towards the data entry position, and where activation of the second switch causes the user interface positioning system to move the user interface in a second direction towards the viewing position. The first and second switches may correspond to first and second push button switches; alternately the first and second switches may correspond to first and second touch sensitive regions on the user interface.

In another aspect, the user interface position selector may be comprised of a first touch sensitive region and a second touch sensitive region, where touching the first touch sensitive region with a finger and moving the finger in a downward motion on the user interface causes the user interface positioning system to move the user interface to the data entry position, and where touching the second touch sensitive region with a finger and moving the finger in an upward motion on the user interface causes the user interface positioning system to move the user interface to the viewing position.

In another aspect, the user interface position selector may be comprised of a touch sensitive region extending over a portion of the user interface, where touching the touch sensitive region with a finger and moving the finger in a downward motion within the touch sensitive region causes the user interface positioning system to move the user interface in a first direction towards the data entry position, and where touching the touch sensitive region with a finger and moving the finger in an upward motion within the touch sensitive region causes the user interface positioning system to move the user interface in a second direction towards the viewing position.

In another aspect, the user interface position selector may be comprised of a touch sensitive region extending over a portion of the user interface, where tapping the touch sensitive region with a finger causes the user interface positioning system to move the user interface to a corresponding position between the data entry position and the viewing position.

In another aspect, the vehicle interface system may further include (i) a controller coupled to the user interface positioning system, and (ii) a vehicle status monitor coupled to the controller, where the vehicle status monitor outputs a first control signal when the vehicle is activated and a second control signal when the vehicle is de-activated, where the controller causes the user interface positioning system to place the user interface in the data entry position upon receipt of the first control signal and in the viewing position upon receipt of the second control signal.

In another aspect, the vehicle interface system may further include (i) a controller coupled to the user interface positioning system, and (ii) a vehicle status monitor coupled to the controller, where the vehicle status monitor outputs a first control signal when the vehicle is placed in drive and a second control signal when the vehicle is placed in park, where the controller causes the user interface positioning system to place the user interface in the data entry position upon receipt of the first control signal and in the viewing position upon receipt of the second control signal.

A further understanding of the nature and advantages of the present invention may be realized by reference to the remaining portions of the specification and the drawings.

### BRIEF DESCRIPTION OF THE DRAWINGS

It should be understood that the accompanying figures are only meant to illustrate, not limit, the scope of the invention and should not be considered to be to scale. Additionally, the same reference label on different figures should be understood to refer to the same component or a component of similar functionality.

FIG. 1 provides a system level diagram of exemplary EV vehicle systems that may utilize the adjustable user interface of the invention;

FIG. 2 provides a similar system level diagram to that shown in FIG. 1, modified for an ICE-based vehicle;

FIG. 3 provides a perspective view of an embodiment of the invention with the touch screen user interface positioned in a lower, data entry position;

FIG. 4 provides a perspective view of the embodiment of the touch screen user interface shown in FIG. 3 positioned in an intermediate position;

FIG. 5 provides a perspective view of the embodiment of the touch screen user interface shown in FIGS. 3 and 4, positioned in a raised, viewing position;

FIGS. 6A-6C provide a side view of the touch screen user interface shown in FIGS. 3-5;

FIG. 7 illustrates the positioning of the user interface to achieve optimum ergonomics;

FIGS. 8A-8C provide a side view of an alternate touch screen user interface linkage assembly;

FIGS. 9A-9C illustrate the configuration shown in FIGS. 8A-8C with additional levels of motion;

FIGS. 10A-10C provide a side view of an alternate touch screen user interface linkage assembly in which the interface display is hinged;

FIGS. 11A-11C illustrate the configuration shown in FIGS. 10A-10C modified to include a telescopic linkage arm;

FIG. 12 illustrates an interface position selector that utilizes a rotatable knob, where the knob is rotatable between a first position corresponding to the interface being located in the data entry position and a second position corresponding to the interface being located in the viewing position;

FIG. 13 illustrates an interface position selector that utilizes a rotatable knob, where the knob may be located at any of a plurality of positions between a first position corresponding to the interface being located in the data entry position and a second position corresponding to the interface being located in the viewing position;

FIG. 14 illustrates an interface position selector comprised of a pair of buttons where the first button causes the user interface to be placed in the data entry position and the second button causes the user interface to be placed in the viewing position;

FIG. 15 illustrates an interface position selector comprised of a pair of buttons where the first button causes the user interface to move upwards toward the viewing position and the second button causes the user interface to move downwards towards the data entry position;

FIG. 16 illustrates an interface position selector utilizing the touch screen, wherein if the user touches the interface near the bottom of the screen and flicks their finger in an upward direction the interface moves upward to the viewing position, and wherein if the user touches the interface near the top of the screen and flicks their finger in a downward direction the interface moves downward to the data entry position;

FIG. 17 illustrates a modification of the interface position selector of FIG. 16 in which the user interface is divided into zones, thereby allowing the user to select between at least three interface positions; and

FIG. 18 illustrates an interface position selector utilizing the touch screen in which a portion of the interface is used as a slider control to input the desired interface position.

### DESCRIPTION OF THE SPECIFIC EMBODIMENTS

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, process steps, operations, elements, and/or components, but do not preclude the presence or addition of one or more other features, process steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps, calculations, or components, these steps, calculations, or components should not be limited by these terms, rather these terms are only used to distinguish one step, calculation, or component from another. For example, a first calculation could be termed a second calculation, and, similarly, a first step could be termed a second step, and, similarly, a first component could be termed a second component, without departing from the scope of this disclosure. The term “battery pack” as used herein refers to one or more batteries electrically interconnected to achieve the desired voltage and capacity. In the following text, the terms “electric vehicle” and “EV” may be used interchangeably and may refer to an all-electric vehicle, a plug-in hybrid vehicle, also referred to as a PHEV, or a hybrid vehicle, also referred to as a HEV, where a hybrid vehicle utilizes multiple sources of propulsion including an electric drive system.

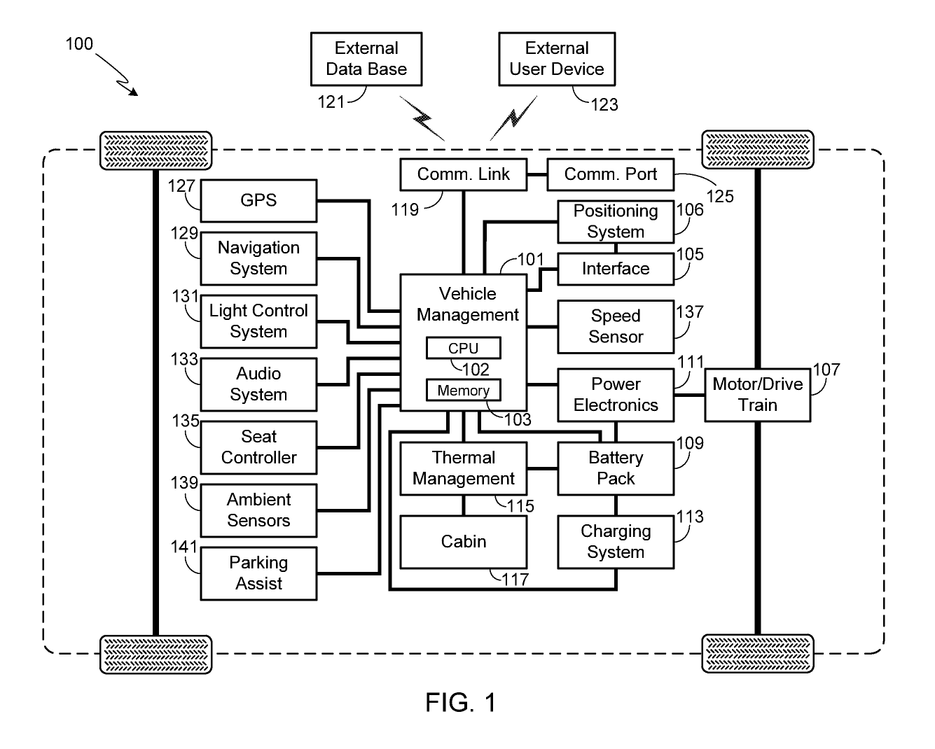

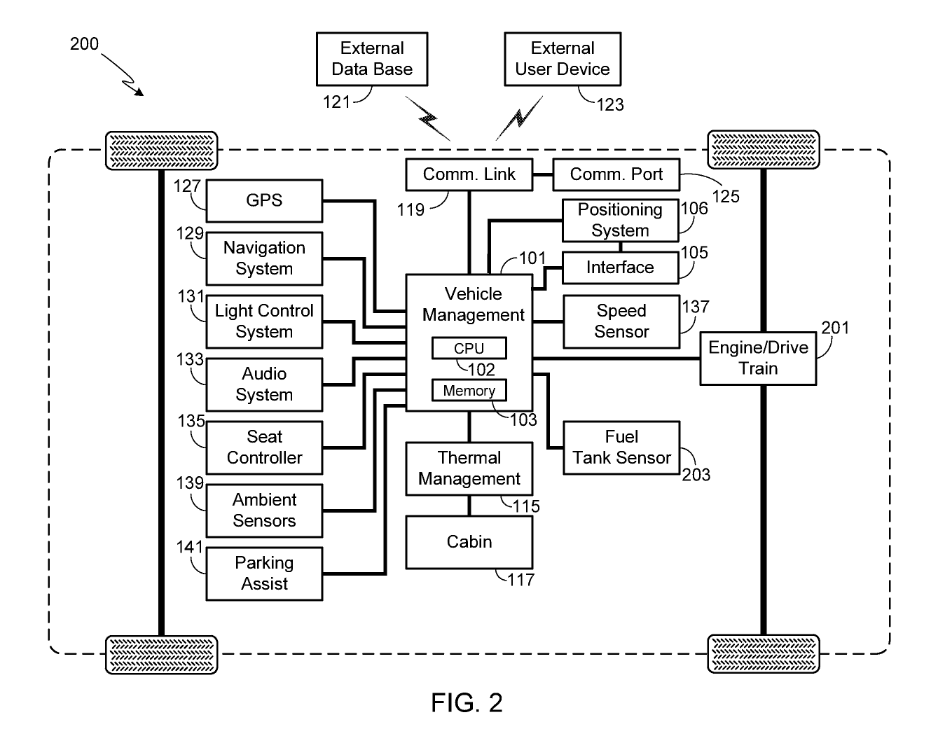

FIG. 1 is a high-level view of some of the primary systems of an EV 100, systems which may provide information to, and/or be controlled by, vehicle occupants via the user interface of the invention. As described in further detail below with reference to FIG. 2, the invention may also be used with a vehicle utilizing an internal combustion engine (ICE), either alone or in combination with an electric motor (i.e., a hybrid). It should be understood that the system configurations illustrated in FIGS. 1 and 2 are but two possible configurations and that other configurations may be used while still retaining the functionality of the invention. Additionally, one or more of the elements shown in FIGS. 1 and 2 can be grouped together in a single device, and/or circuit board, and/or integrated circuit.

EV 100 includes a vehicle system controller 101, also referred to herein as a vehicle management system. Controller 101 includes a central processing unit (CPU) 102 and a memory 103, with memory 103 being comprised of EPROM, EEPROM, flash memory, RAM, solid state drive, hard disk drive, or any other type of memory or combination of memory types. Controller 101 may also include a graphical processing unit (GPU), with the GPU being either separate from or contained on the same chip set as the CPU.

A touch screen user interface 105, described in detail below, is coupled to vehicle management system 101. Interface 105, which may use any of a variety of display technologies (e.g., light-emitting diode (LED), plasma, organic light-emitting diode (OLED), liquid crystal (LCD), thin film transistor LCD (TFT-LCD), field emission display (FED) or other technology), incorporates a touch sensitive screen technology (e.g., capacitive touch technology). Touch screen user interface 105 allows the driver, or a passenger, to interact with the vehicle management system, for example inputting data into the navigation system, altering the heating, ventilation and air condition (HVAC) system, controlling the vehicle's entertainment system (e.g., radio, CD/DVD player, etc.), adjusting vehicle settings (e.g., seat positions, light controls, etc.), and/or otherwise altering the functionality of EV 100. Touch screen user interface 105 also includes means for the vehicle management system to provide information to the driver and/or passenger, information such as a navigation map or driving instructions as well as the operating performance of any of a variety of vehicle systems (e.g., battery pack charge level for an EV, fuel level for an ICE-based vehicle, selected gear, current entertainment system settings such as volume level and selected track information, external light settings, current vehicle speed, current HVAC settings such as cabin temperature and/or fan settings, etc.). Touch screen user interface 105 may also be used to warn the driver of a vehicle condition (e.g., low battery charge level or low fuel level) and/or communicate an operating system malfunction (battery system not charging properly, low oil pressure for an ICE-based vehicle, low tire air pressure, etc.). It should be understood that while the focus of the present invention is on a touch screen user interface 105, typically the user interface of the vehicle will also include other displays (e.g., a centrally mounted speedometer or other gauge), physical switches (e.g., push-button switches, capacitive switches, slide or toggle switches), and system warning indicators (e.g., audible or visible warning signals).

EV 100 includes one or more motors 107 that provide vehicle propulsion. Motor(s) 107 may be mechanically coupled to the front axle/wheels, the rear axle/wheels, or both, and may utilize any of a variety of transmission types (e.g., single speed, multi-speed) and differential types (e.g., open, locked, limited slip). Battery pack 109, which may be comprised of one or hundreds or thousands of rechargeable batteries, supplies the power necessary for operation of motor(s) 107. Additionally, battery pack 109 may provide the power necessary for the various vehicle systems that require electrical power (e.g., lights, entertainment system, navigation system, etc.). Typically battery pack 109 is coupled to motor(s) 107 via a power control system 111 that insures that the power delivered to the drive motor is of the proper form (e.g., correct voltage, current, waveform, etc.).

Battery pack 109 is charged by charging system 113. Charging system 113 may either be integrated into EV 100 as shown, or be comprised of an external charging system. Typically charging system 113 is configured to be electrically connected to an external power source, not shown, such as the municipal power grid. Battery pack 109 may also be charged, at least in part, using an on-board system such as a regenerative braking system.

EV 100 also includes a thermal management system 115. Thermal management system 115, which includes both a heating subsystem and a cooling subsystem, is used to insure that the batteries within battery pack 109 are maintained within the desired operating, charging and/or storage temperature range. Preferably thermal management system 115 is also coupled to the passenger cabin HVAC system 117.

Coupled to vehicle management system 101 is a communication link 119. Communication link 119 may be used to wirelessly obtain configuration updates or other information from external data sources 121 (e.g., manufacturer, dealer, service center, web-based application, remote home-based system, third party source, etc.) using any of a variety of different technologies (e.g., GSM, EDGE, UMTS, CDMA, DECT, WiFi, WiMax, etc.). Communication link 119 may also be used to wirelessly couple the system to a user device 123 (e.g., a cell phone, MP3 player, etc.). In some embodiments, communication link 119 also includes an on-board port 125, such as a USB, Thunderbolt, or other port, in order to couple an external device (e.g., cell phone, MP3 player, data source, test system) over a wired communication link, thus allowing system updates or other information to be supplied to the vehicle management system 101.

In addition to vehicle propulsion and related systems, vehicle 100 includes multiple secondary systems that are coupled to vehicle management system 101. User interface 105, which is also coupled to vehicle management system 101, may be used to obtain the status of various aspects of these systems and, in at least some instances, provide the user with a means for making system adjustments. Exemplary secondary systems include a global positioning system (GPS) 127, navigation system 129, light control system 131 (e.g., external vehicle lights, cabin lighting, fog lights, etc.), entertainment system 133 (e.g., MP3 player, CD/DVD player, SAT receiver, etc.), seat positioning controller 135, vehicle speed sensor 137, ambient environment sensors 139 (e.g., precipitation, temperature, light level, etc.), and parking assist sensors 141. It should be understood that the systems listed above are only meant to illustrate appropriate systems that may be coupled to user interface 105 via vehicle management system 101, and as such is not meant to provide an exhaustive listing of all the vehicle and auxiliary subsystems that may be monitored by, or controlled by, user interface 105.

FIG. 2 provides a high-level view of a second vehicle configuration, integrated into an ICE-based vehicle, suitable for use with the adjustable user interface. As shown, motor 107 of vehicle 100 is replaced in vehicle 200 with engine 201. Due to the use of engine 201, vehicle 200 does not include battery pack 109, power electronics subsystem 111 or charging system 113. As opposed to monitoring the battery pack, in vehicle 200 vehicle management system 101 monitors fuel tank 203. It will be appreciated that the invention is equally applicable to a hybrid vehicle.

In accordance with the present invention, the position of touch screen user interface 105 is adjustable between at least two positions and more preferably adjustable over a range of positions. By allowing the user the ability to adjust the position of interface 105, the user can optimize screen placement for either data entry or viewing. Additionally, the screen position can be optimized for the user's seating position, thus allowing easy access regardless of seat position. As a result, when the screen is being used for viewing, for example when the screen is being used with navigation system 129, the user can easily see the screen without having to look downward or dramatically alter their viewing angle. Similarly, when the screen is being used for data entry, for example to input data into navigation system 129 or make adjustments to audio system 133, the screen can be positioned so that the user can easily reach the entire screen without straining, thereby helping to avoid neck, shoulder and/or back pain.

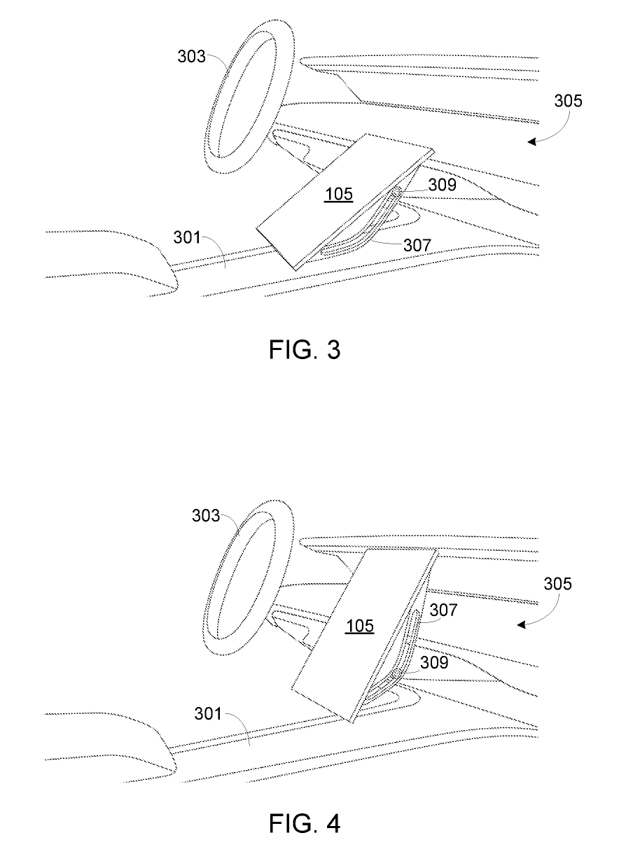

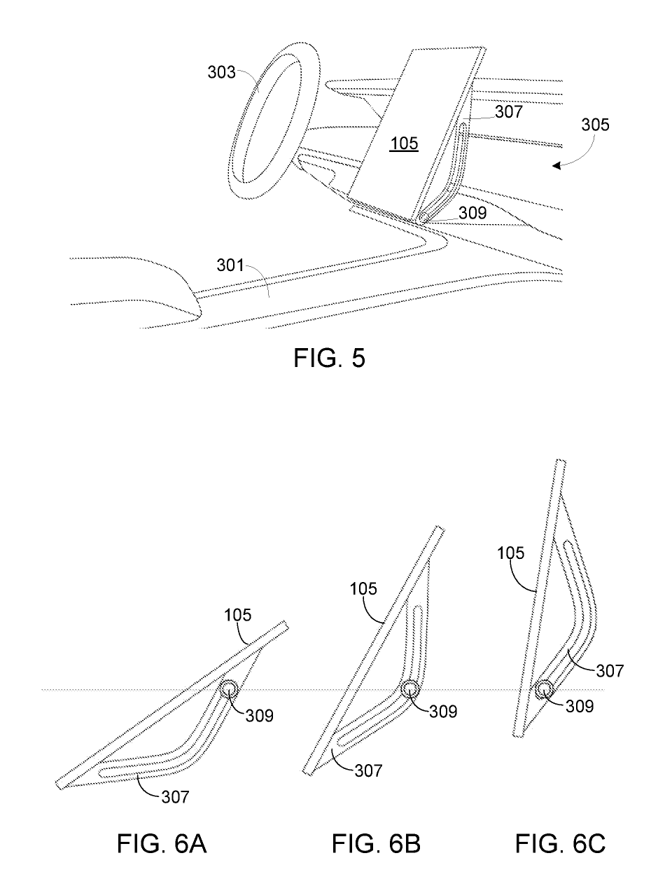

FIGS. 3-5 illustrate a preferred embodiment of the invention, these views providing a perspective view of touch screen user interface 105 located in various positions within the passenger cabin of a vehicle. In order to provide locational context for interface 105, also visible in FIGS. 3-5 is an exemplary center console 301, steering wheel 303 and dash 305. For further clarity, FIGS. 6A-6C provide a side view of interface 105 that illustrate the interface's range of motion.

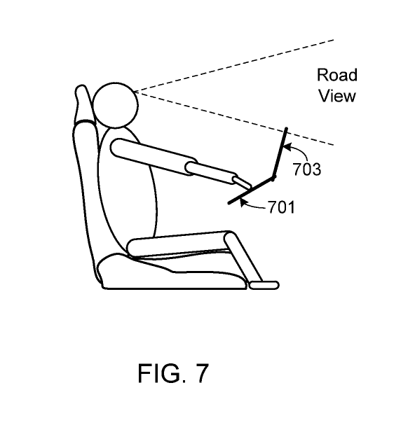

As shown in the figures, preferably touch screen user interface is centrally located between the left front and right front seats, thus allowing access to the interface by either the driver or the passenger. In some embodiments the interface may be angled towards the driver, and/or positioned closer to the driver's side of the vehicle, thus providing improved driver access to the interface. It should be understood that the embodiment illustrated in FIGS. 3-6 is only meant as an exemplary embodiment, and that variations of this embodiment are clearly envisioned by the inventor. For example, although display 105 preferably has a screen size in the range of 15-19 inches (e.g., measured diagonally), the screen may fall outside of this range (either smaller or larger). Similarly, the touch screen interface may have a different range of motion than shown, for example lying in a more horizontal plane when in the data entry position and/or in a more vertical plane when in the viewing position. In at least one embodiment, touch screen 105 is positioned within 30 degrees of the horizontal plane when in the data entry position, and positioned within 45 degrees of the vertical plane when in the viewing position. Preferably the range of motion used for a particular configuration of interface 105 is based on the ergonomics of the vehicle into which it is to be integrated, thus insuring that in the data entry position (see interface position 701 in FIG. 7) the touch screen is in a natural location for use by the driver and that in the viewing position (see interface position 703 in FIG. 7) the touch screen is optimized to provide easy viewing while minimally affecting the driver's view of the road and the ambient environment.

In the embodiment illustrated in FIGS. 3-6, user interface 105 includes one or more guide tracks 307 that allow the interface to pivot about pivot axis 309. The position of user interface 105 may be adjusted manually, for example by gripping the interface (or gripping a handle or handles coupled to the interface) and moving interface 105 to the desired location. In the preferred embodiment, however, the system allows the user to quickly and easily re-position interface 105 using a mechanical, electro-mechanical, or hydraulic positioning system 106 that is coupled to the interface 105 and the interface linkage.

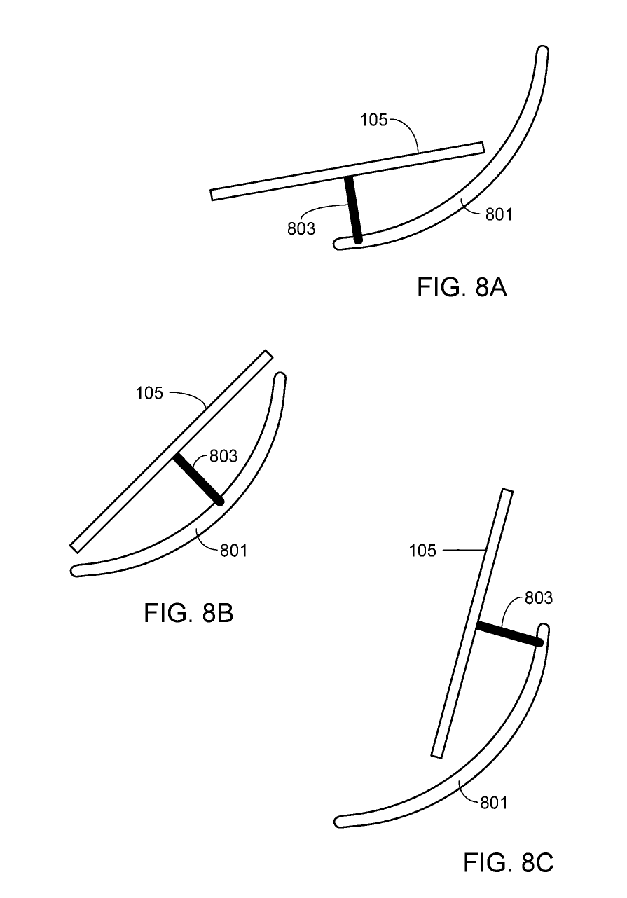

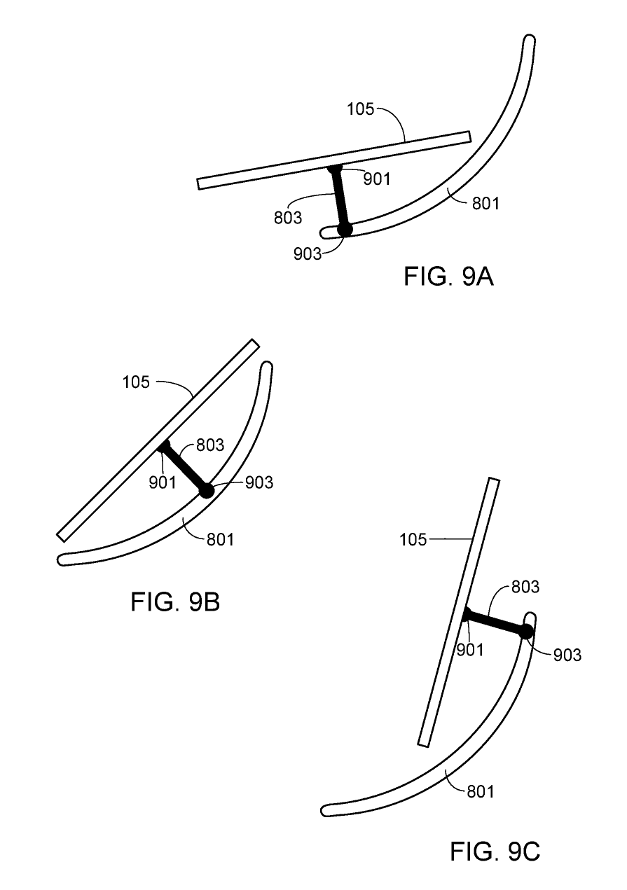

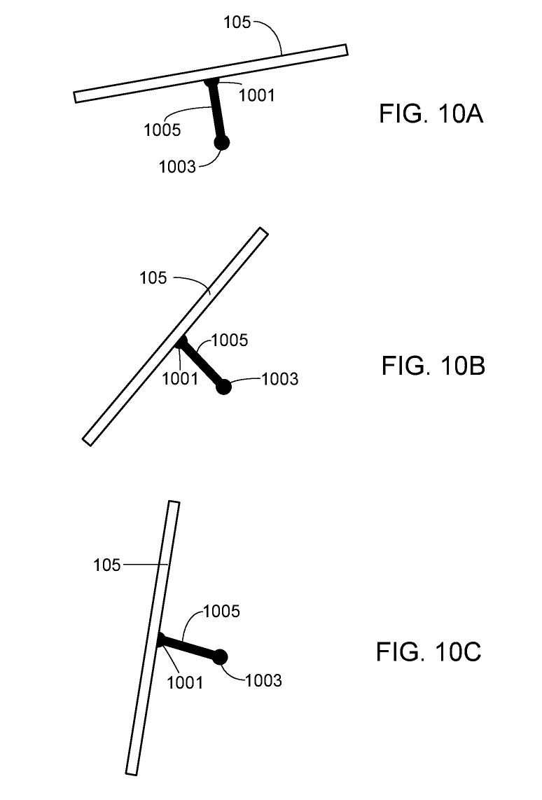

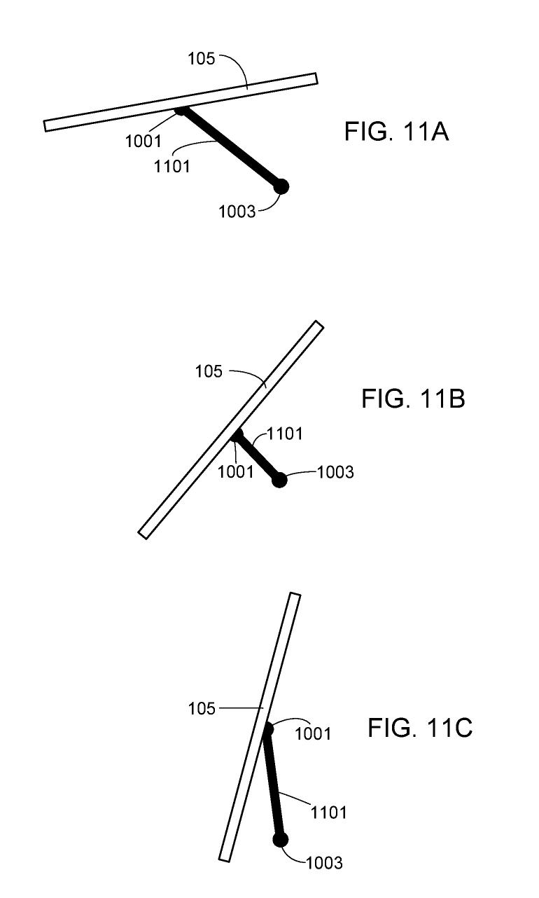

Although the approach of using a guide track mounted to the rear portion of interface 105 is preferred as it is easily implemented and provides a stable positioning system, it should be understood that other tracking and linkage assemblies may be used to provide the desired range of motion for touch screen user interface 105. For example, FIGS. 8A-8C illustrate another embodiment in which a guide track 801 is integrated into the center console as well as a portion of the dashboard. User interface 105 is coupled to guide track 801 via a linkage arm (or arms) 803. As linkage arm(s) 803 moves within guide track 801, interface 105 is moved between a data entry position (FIG. 8A) to an interface viewing position (FIG. 8C). If desired, and as illustrated in FIGS. 9A-9C, interface 105 may be configured to allow it to pivot about linkage arm 803 at axis 901, and/or linkage arm 803 may be configured to allow it to pivot about guide track 801 at axis 903, thereby providing additional freedom of motion for the interface. FIGS. 10A-10C illustrate another linkage assembly in which user interface 105 pivots about axes 1001 and 1003 using a pair of hinge mounts located on either end of linkage arm 1005, thereby providing interface motion without the need for a guide track. In general, however, the inventor has found that for most vehicle configurations the embodiment shown in FIGS. 10A-10C does not provide the desired level of interface motion. This limitation of the embodiment of FIGS. 10A-10C is alleviated in the embodiment shown in FIGS. 11A-11C in which linkage arm 1005 is replaced with a telescopic linkage arm 1101. Telescopic linkage arm 1101 allows the separation distance between the interface and the vehicle console to be adjusted, thereby dramatically improving upon the range of achievable motion.

In at least one embodiment, vehicle management system 101 is configured to automatically relocate user interface 105 to a preset location when the vehicle is placed into ‘park’; alternately, when the vehicle is turned ‘off’. Similarly, vehicle management system 101 may be configured to automatically relocate user interface 105 to a second preset location when the vehicle is first placed into drive; alternately, when the vehicle is initially turned ‘on’. The first interface preset position may be selected to minimize the risk of the display being damaged as vehicle occupants either enter, or exit, the passenger cabin. Accordingly, the first preset position may correspond to the upper, viewing position. The second interface preset position may be selected to allow immediate data entry upon starting the car and as such, the second preset position may correspond to the lower, data entry position. The preset interface positions may be preset by the vehicle's manufacturer. Alternately, the system may be configured to allow selection of the preset positions by either the end user or a third party.

As previously noted, although the system of the invention may be configured to allow manual positioning of the user interface, preferably a positioning system 106 is used, thereby simplifying interface placement. Positioning system 106 may utilize an electro-mechanical (e.g., motorized) positioner, a hydraulic positioner or other positioning system to adjust and control the viewing position of user interface 105. In some configurations of the invention, positioning system 106 only provides two positions for interface 105; a lower, data entry position and an upper, display viewing position. In an alternate configuration, positioning system 106 provides for multiple positions, including the lower, data entry position, the upper, display viewing position, and one or more positions there between.

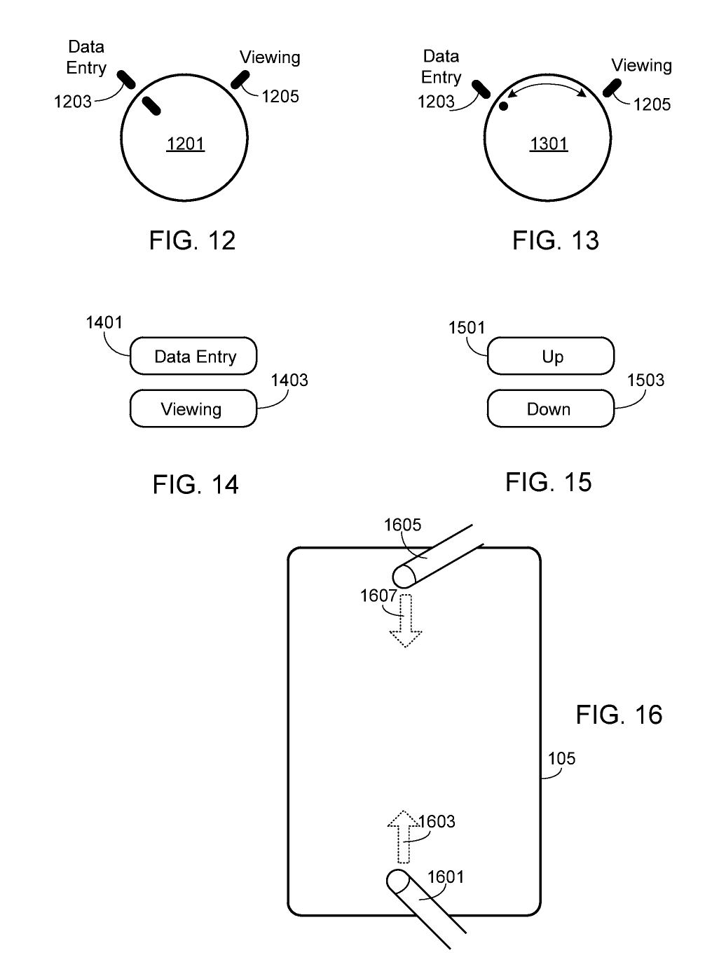

It will be appreciated that there are a variety of input devices that may be used in conjunction with the vehicle management system 101 and the interface positioning system 106 that allow a user to select the desired interface position. Appropriate selection devices include, but are not limited to, slide controllers, push buttons, rotating switches, and touch screen buttons and sliders. Exemplary selection devices are illustrated in FIGS. 12-18 and described in detail below.

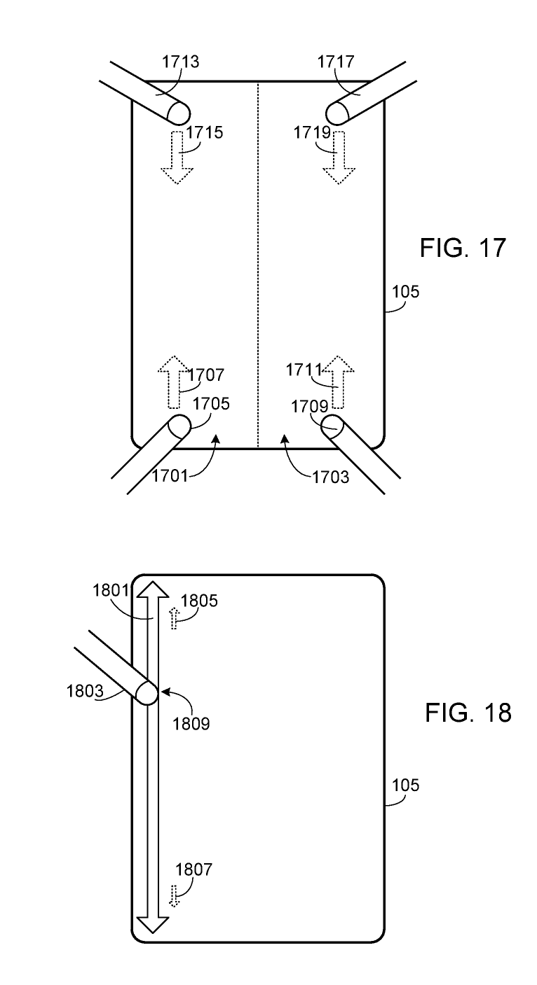

FIG. 12 illustrates an interface position selector that utilizes a rotatable knob 1201. In this configuration, knob 1201 may be rotated between a first position 1203 (e.g., data entry position) and second position 1205 (e.g., viewing position). FIG. 13 illustrates a modification of this input device, where the rotatable knob 1301 may be located at any position between position 1203 and 1205, resulting in the user interface being placed at a corresponding location between the data entry position and the viewing position. FIG. 14 illustrates an alternate input device comprised of a pair of buttons 1401 and 1403, the first button 1401 causing the user interface to be placed in the data entry position and the second button 1403 causing the user interface to be placed in the viewing position. Buttons 1401/1403 may be physical buttons, for example buttons mounted on the dash board or the central console, or buttons 1401/1403 may be touch sensitive buttons, e.g., regions displayed on user interface 105. FIG. 15 illustrates a modification of the input device shown in FIG. 14, where buttons 1501/1503 cause the user interface to move in the corresponding direction, e.g., upwards toward the viewing position when button 1501 is pressed and downwards towards the data entry position when button 1503 is pressed. As in the prior embodiment, buttons 1501/1503 may be physical buttons or touch sensitive buttons displayed on user interface 105. FIG. 16 illustrates another technique for selecting interface position. In this approach, when the user touches interface 105 near the bottom of the screen and flicks their finger 1601 in an upward direction 1603, user interface 105 moves upward to the viewing position. Similarly, when the user touches interface 105 near the top of the screen and flicks their finger 1605 in a downward direction 1607, user interface 105 moves downward to the data entry position. FIG. 17 illustrates a technique similar to that shown in FIG. 16, but modified to allow more than just two interface positions, i.e., data entry and viewing. In FIG. 17 user interface 105 is divided into two zones, 1701 and 1703, although it will be understood that the interface may be divided into more than two zones if additional interface positions are desired. In this embodiment when the user touches interface 105 near the bottom of the screen within zone 1701 and flicks their finger 1705 in an upward direction 1707, user interface 105 moves upward to the viewing position. If the user flicks their finger 1709 in an upward direction 1711 from within zone 1703, then user interface 105 only moves to an intermediate position between the data entry and the viewing positions. Similarly, when the user touches interface 105 near the top of the screen within zone 1701 and flicks their finger 1713 in a downward direction 1715, user interface 105 moves downward to the data entry position. If the user flicks their finger 1717 in a downward direction 1719 from within zone 1703, then user interface 105 moves to the intermediate position. In yet another approach, and as illustrated in FIG. 18, a portion 1801 of interface 105 is used as a slider control to input the desired interface position. To adjust the position, the user presses their finger 1803 on zone 1801 and moves their finger 1803 upwards (direction 1805) or downwards (direction 1807) to move the user interface 105 upwards or downwards to the extent desired. Alternately, the user can tap a location on zone 1801, causing the user interface 105 to move to a corresponding position, e.g., a tap two thirds of the way towards the top of zone 1801 (region 1809) would cause the user interface to move two thirds of the way towards the raised, viewing position.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention.

What is claimed is:

1. A vehicle interface system, comprising:
a user interface mounted within a passenger cabin of a vehicle, wherein said user interface is a touch screen, and wherein said user interface is adjacent to a driver seat of said vehicle;
a user interface positioning system coupled to said user interface, wherein said user interface positioning system is adjustable between at least a first user interface position and a second user interface position, wherein said user interface in said first user interface position corresponds to a data entry position, wherein said user interface in said second user interface position corresponds to a viewing position, wherein said user interface in said data entry position is lower within said passenger cabin than when said user interface is in said viewing position, wherein said user interface in said data entry position is closer to said driver seat than when said user interface is in said viewing position, and wherein said user interface in said viewing position is closer to a vehicle windshield than when said user interface is in said data entry position; and
a user interface position selector coupled to said user interface positioning system, wherein said user interface position selector is settable to a least a first setting and a second setting, wherein said user interface position selector in said first setting causes said user interface positioning system to place said user interface in said first user interface position, wherein said user interface position selector in said second setting causes said user interface positioning system to place said user interface in said second user interface position, and wherein said user interface position selector is settable by a vehicle driver.

2. The vehicle interface system of claim 1, wherein said user interface is within 30 degrees of a horizontal plane when said user interface is in said data entry position.

3. The vehicle interface system of claim 1, wherein said user interface is within 45 degrees of a vertical plane when said user interface is in said viewing position.

4. The vehicle interface system of claim 1, wherein said user interface is centrally located between said driver seat and an adjacent passenger seat.

5. The vehicle interface system of claim 1, wherein said user interface position selector is settable to any of a plurality of settings between said first setting and said second setting, wherein said plurality of settings corresponds to a plurality of user interface positions between said data entry position and said viewing position.

6. The vehicle interface system of claim 1, said user interface positioning system further comprising an electro-mechanical positioning system.

7. The vehicle interface system of claim 1, said user interface positioning system further comprising a hydraulic positioning system.

8. The vehicle interface system of claim 1, further comprising a linkage assembly controllable by said user interface positioning system, wherein said user interface is mounted within said passenger cabin of said vehicle with said linkage assembly, and wherein said user interface positioning system utilizes said linkage assembly to adjust said user interface between at least said first user interface position and said second user interface position based on an input from said user interface position selector.

9. The vehicle interface system of claim 8, said linkage assembly further comprising a guide track mounted to said vehicle, wherein a link of said linkage assembly slides within said guide track, wherein a position of said link within said guide track is controlled by said user interface positioning system, and wherein said user interface positioning system positions said link of said linkage assembly within said guide track to adjust said user interface between at least said first user interface position and said second user interface position based on said input from said user interface position selector.

10. The vehicle interface system of claim 8, said linkage assembly further comprising a guide track mounted to a portion of said user interface, wherein said guide track moves about a pivot mounted to said vehicle, wherein a position of said guide track relative to said pivot is controlled by said user interface positioning system, and wherein said user interface positioning system positions said guide track relative to said pivot to adjust said user interface between at least said first user interface position and said second user interface position based on said input from said user interface position selector.

11. The vehicle interface system of claim 8, said linkage assembly further comprising at least one link coupling a user interface hinge mount to a passenger cabin hinge mount, wherein said user interface hinge mount is attached to a rear portion of said user interface, and wherein said passenger cabin hinge mount is fixed to said passenger cabin of said vehicle.

12. The vehicle interface system of claim 11, said at least one link further comprising a telescoping link, wherein a link length corresponding to said telescoping link is controlled by said user interface positioning system.

13. The vehicle interface system of claim 1, said user interface position selector further comprising a rotatable knob, wherein said rotatable knob rotated to a first position corresponds to said first setting, and wherein said rotatable knob rotated to a second position corresponds to said second setting.

14. The vehicle interface system of claim 13, wherein said rotatable knob is settable to any of a plurality of settings between said first position and said second position, wherein said plurality of settings corresponds to a plurality of user interface positions between said data entry position and said viewing position.

15. The vehicle interface system of claim 1, said user interface position selector further comprising a first switch and a second switch, wherein activation of said first switch selects said first setting, and wherein activation of said second switch selects said second setting.

16. The vehicle interface system of claim 15, said first switch comprising a first push button switch and said second switch comprising a second push button switch.

17. The vehicle interface system of claim 15, said first switch comprising a first touch sensitive region on said user interface and said second switch comprising a second touch sensitive region on said user interface.

18. The vehicle interface system of claim 1, said user interface position selector further comprising a first switch and a second switch, wherein activation of said first switch causes said user interface positioning system to move said user interface in a first direction towards said data entry position, and wherein activation of said second switch causes said user interface positioning system to move said user interface in a second direction towards said viewing position.

19. The vehicle interface system of claim 18, said first switch comprising a first push button switch and said second switch comprising a second push button switch.

20. The vehicle interface system of claim 18, said first switch comprising a first touch sensitive region on said user interface and said second switch comprising a second touch sensitive region on said user interface.

21. The vehicle interface system of claim 1, said user interface comprising a first touch sensitive region and a second touch sensitive region, wherein touching said first touch sensitive region with a finger and moving said finger in a downward motion on said user interface causes said user interface positioning system to move said user interface to said data entry position, and wherein touching said second touch sensitive region with said finger and moving said finger in an upward motion on said user interface causes said user interface positioning system to move said user interface to said viewing position.

22. The vehicle interface system of claim 1, said user interface comprising a touch sensitive region extending over a portion of said user interface, wherein touching said touch sensitive region with a finger and moving said finger in a downward motion within said touch sensitive region causes said user interface positioning system to move said user interface in a first direction towards said data entry position, and wherein touching said touch sensitive region with said finger and moving said finger in an upward motion within said touch sensitive region causes said user interface positioning system to move said user interface in a second direction towards said viewing position.

23. The vehicle interface system of claim 22, wherein tapping said touch sensitive region with said finger causes said user interface positioning system to move said user interface to a corresponding position between said data entry position and said viewing position.

24. The vehicle interface system of claim 1, further comprising:
a controller coupled to said user interface positioning system; and
a vehicle status monitor coupled to said controller, wherein said vehicle status monitor outputs a first control signal when said vehicle is activated, wherein said vehicle status monitor outputs a second control signal when said vehicle is de-activated, wherein said controller causes said user interface positioning system to place said user interface in said data entry position upon receipt of said first control signal, and wherein said controller causes said user interface positioning system to place said user interface in said viewing position upon receipt of said second control signal.

25. The vehicle interface system of claim 1, further comprising:
a controller coupled to said user interface positioning system; and
a vehicle status monitor coupled to said controller, wherein said vehicle status monitor outputs a first control signal when said vehicle is placed in drive, wherein said vehicle status monitor outputs a second control signal when said vehicle is placed in park, wherein said controller causes said user interface positioning system to place said user interface in said data entry position upon receipt of said first control signal, and wherein said controller causes said user interface positioning system to place said user interface in said viewing position upon receipt of said second control signal.
